(19) United States
(12) Patent Application Publication
(10) Pub. No.: US 2010/0315311 A1
(43) Pub. Date: Dec. 16, 2010

(54) ANTENNA MODULE INCLUDING INTEGRATED RADOME

(75) Inventor: Sylvie Touchard, Dourdan (FR)

Correspondence Address: LARIVIERE, GRUBMAN & PAYNE, LLP, 19 UPPER RAGSDALE DRIVE, SUITE 200, MONTEREY, CA, 93940, US

(73) Assignee: Thales, Neuilly-Sur-Seine (FR)

(21) Appl. No.: 12/670,924

(22) PCT Filed: Jul. 22, 2008
(86) PCT No.: PCT/EP08/59615

§ 371 Date: Jun. 25, 2010

(30) Foreign Application Priority Data
Jul. 27, 2007 (FR) 07/05523

(51) Int. Cl. H01Q 1/42; H01P 11/00

(52) U.S. Cl. 343/872; 29/600

(57) ABSTRACT

The invention relates to an antenna module comprising at least a first series of unitary radiating elements (ER₁ᵢ), from a second series of unitary radiating elements (ER₂ᵢ) facing the unitary radiating elements of the first series, so as to broaden the frequency band of said antenna module, characterized in that it further includes:
a monolithic part made of dielectric material having a face supporting the first series of radiating elements and legs (P₁ᵢ), the surfaces of which are conducting;
a microwave dielectric circuit supporting the second series of radiating elements; and
means for fastening the legs of the monolithic part to said microwave dielectric circuit, the monolithic part providing a radome function for the radiating elements.

### PRIORITY CLAIM

This application claims priority to PCT Patent Application Number PCT/EP2008/059615, entitled Antenna Module Including Integrated Radome, filed Jul. 22, 2008.

### FIELD OF THE INVENTION

The invention relates to broadband antenna modules having at least two levels of protected radiating elements and incorporating a radome structure.

### BACKGROUND OF THE INVENTION

In general, the frequency band of an antenna may be broadened using several levels of radiating elements and notably by using the coupling of pairs or radiating elements facing each other and therefore able to be in resonance. To give an example with a first level of radiating elements, transmission over 4% of the bandwidth may typically be obtained, that is to say, for signal transmission with transmission frequencies between the frequencies ν₁ and ν₂, the bandwidth ratio defined by the expression:

2(ν₂−ν₁)/(ν₁+ν₂)

may typically be around 4%, whereas, using a first level and a second level of radiating elements facing each other it is possible to triple this percentage bandwidth.

In general, the radiating elements of an antenna are protected by a radome consisting of a cover made of dielectric material that seals the antenna without disturbing the transmitted signal. To protect structures having two levels of radiating elements, it is known to use, as illustrated in FIG. 1, a first level N₁ comprising radiating elements ER₁ᵢ produced on the surface of a dielectric, which typically may be an RO4003 substrate with a thickness close to 1.6 mm. A second level N₂ of radiating elements ER₂ᵢ also produced on a multilayer substrate of the same RO4003 type, making it possible to integrate various electrical functions of the filter, calibration element, connection array type, is placed facing the first level via a metal armature Ar for providing the desired electromagnetic coupling. Thus in the case of a double structure, sealing may be provided directly by the upper substrate.

### SUMMARY OF THE INVENTION

To produce low-cost antennas of simplified design, the present invention proposes to produce an antenna incorporating a radome function coupled to a radiating-element support function thanks to the use of a monolithic part made of dielectric material having lateral legs, the surfaces of which are made conducting.

More precisely, one subject of the invention is an antenna module comprising at least a first series of unitary radiating elements, a second series of unitary radiating elements facing the unitary radiating elements of the first series, so as to broaden the frequency band of said antenna module, characterized in that it further includes:
a monolithic part made of dielectric material having a face supporting the first series of radiating elements and legs, the surfaces of which are conducting;
a microwave dielectric circuit supporting the second series of radiating elements; and
means for fastening the legs of the monolithic part to said microwave dielectric circuit, the monolithic part providing a radome function for the radiating elements.

According to one embodiment of the invention, the surfaces of the legs are metalized.

According to one embodiment of the invention, the elements of the first series of radiating elements and the surfaces of the legs are made of the same metal. Typically, the metal may be nickel or copper protected by nickel, gold, etc.

According to one embodiment of the invention, the dielectric constant of the monolithic part is around 3.

Advantageously, the constituent material of the monolithic part has a thermal expansion coefficient similar to that of the microwave dielectric circuit.

Typically the constituent material of the monolithic part may be polycarbonate, PEEK or other composite material.

Advantageously, the polycarbonate is reinforced by incorporated glass fibers.

According to one embodiment of the invention, the fastening means comprise snap-fastening means that cooperate with inserts.

The fastening means may also comprise screws or even spots of adhesive.

Advantageously, the microwave dielectric circuit is a multilayer circuit having various electrical functions.

According to one embodiment of the invention, the module comprises an array of connections positioned in a strip line via a metalized through-hole or by electromagnetic contact.

The subject of the invention is also a process for manufacturing an antenna module according to the invention, characterized in that it further comprises the following steps:
production of a conducting layer on the surface of the monolithic part having the legs;
discontinuous local removal of zones on the conducting layer produced so as to define the first series of radiating elements; and
fastening of said monolithic part to the support comprising the second series of radiating elements.

According to one embodiment of the invention, the conducting layer is produced by catalytic deposition of a metal.

According to one embodiment of the invention, the conducting layer is produced by vapor deposition.

According to one embodiment of the invention, the local removal is carried out by etching.

### BRIEF DESCRIPTION OF THE DRAWINGS

The invention will be better understood and other advantages will become apparent on reading the following description given by way of non-limiting example and thanks to the appended figures in which:

FIG. 1 illustrates an antenna module according to the prior art which includes a metal armature for providing the electromagnetic coupling function;

FIG. 2 illustrates an antenna module according to the invention, incorporating a monolithic part for providing the radome function;

FIG. 3 illustrates a view from below of the monolithic part having cells in which the radiating elements are positioned; and

FIG. 4 illustrates an example of a microwave dielectric circuit that includes the second series of radiating elements.

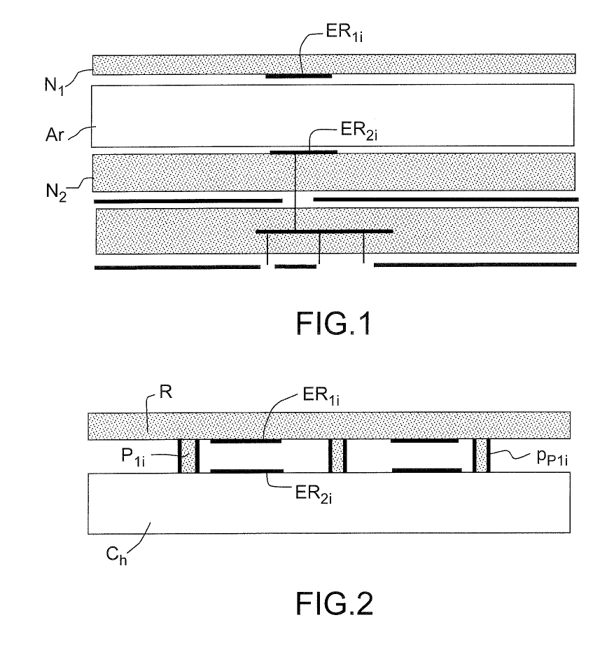

### DETAILED DESCRIPTION OF THE DRAWINGS

The invention proposes an antenna module incorporating a radome providing the function of protecting the module from the outside world and at the same time contributing to the radiation of the antenna. To do this, the radome is produced in a part made of a dielectric material which advantageously has a low porosity, is impermeable to water and possesses low dielectric loss at the operating frequencies of the antenna. As illustrated in FIG. 2, the monolithic part R has, on one side, legs P₁ᵢ and bears, on the other side, on its internal face a first series of radiating elements ER₁ᵢ, also commonly called radiating patches.

The antenna module of the invention further includes a microwave dielectric circuit Cₕ on the surface of which another series of radiating elements ER₂ᵢ is produced. The legs P₁ᵢ have conducting, typically metallic, walls pₚ₁ᵢ, for providing strong coupling between the radiating elements ER₁ᵢ and ER₂ᵢ.

One example of a production process for obtaining such a radome structure comprising radiating elements will now be described below.

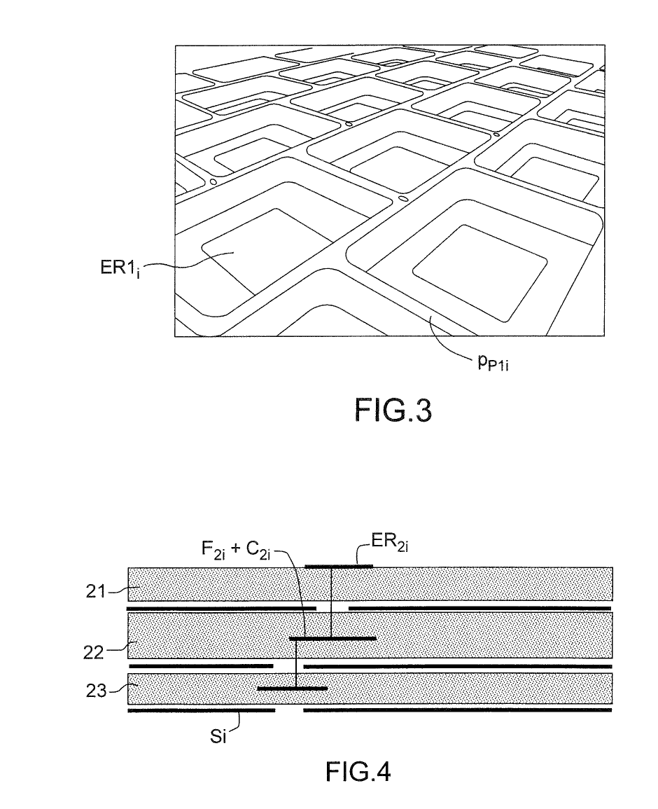

Starting from the constituent dielectric path of the radome, one of the faces thereof, called hereafter the inner face, is machined. The inner face of the radome is machined so as to form a chequerboard layout as illustrated in FIG. 3, which shows a view from below of the monolithic part in which the legs P₁ᵢ are produced by etching. The radiating elements ER₁ᵢ, are positioned in the recess portions, while a metal layer is deposited on the non-recess portions that form the separating walls between the cells, so as to make the legs conducting in order to provide the necessary electromagnetic coupling.

To produce the radiating elements and the conducting legs in a single step, it may be advantageous to metalize the entire recessed inner face of the monolithic part and all of the legs. Thus, an entire conducting surface is provided from which metal is locally and discontinuously removed so as to isolate radiating conducting elements ER₁ᵢ and conducting legs P₁ᵢ.

The antenna module according to the invention also includes a second level of radiating elements ER₂ᵢ.

The advantage of using two patches instead of a single one as radiating element makes it possible for the bandwidth of the antenna to be considerably increased. This is because a single patch has a narrow bandwidth of around 4 to 6%; whereas the bandwidth of 2 patches may be up to 15 or 20%. This is achieved by the electromagnetic coupling between the two patches placed one above the other. By adjusting their respective characteristics (dimensions, thickness and distance separating them), resonance of the device is obtained, enabling the antenna to operate over a broadband.

The radome thus obtained is snap-fastened or bonded or screwed onto the microwave dielectric circuit and the whole assembly formed constitutes a compact antenna panel which can operate outdoors without any other protection. In addition to the advantages of compactness and protection that it affords, such a radome improves the radiation performance of the radiating array thanks to the significant reduction in coupling between the patches of the array. For example, using for this radome a polycarbonate material containing 30% glass fiber, snap-fastened onto the microwave dielectric circuit is highly advantageous for the following reasons:
the permettivity of this material is that of a microwave dielectric substrate close to 3;
the expansion coefficients of this material have the same values as a microwave dielectric circuit; and
the operation of snap-fastening a polycarbonate part costs less than screwing or adhesive bonding operations.

The microwave dielectric circuit supporting the second series of radiating elements ER₂; is advantageously a multilayer circuit having a number of functions for providing the microwave operation of the antenna module of the invention.

Notably it comprises, as illustrated in FIG. 4, a first dielectric layer 21 that includes said radiating elements ER₂ᵢ, the radiating elements being coupled to elementary filters F₂ᵢ and to elementary calibration couplers C₂ᵢ within a second dielectric layer 22, and a third dielectric layer 23 comprises the <<routing>> that corresponds to a connection array for electrically connecting the radiating elements to electrical outputs Si, these being intended to be able to individually connect the radiating elements to module TRs.

The presence of a filter used either at transmission or at reception makes it possible to attenuate the transmitted and/or received signal in the frequency bands in which the antenna does not operate: the role of the filter is therefore not to contaminate the frequency bands other than that of the antenna at transmission and to be protected in the other bands at reception.

The calibration coupler associated with a calibration distribution removes a very small portion of the transmitted or received signal, constituting the calibration signal. This is used to calibrate the antenna and therefore to factor out imperfections of the constituent elements of the antenna that are located behind the radiating elements (such as the filters).

In the case of calibration signals, the principle of a distributor in the form of a dielectric layer in the antenna has the virtue of being simple, robust, and stable over time.

According to another embodiment of the invention, the elementary filters, the elementary couplers and the elementary electrical outputs may advantageously be produced on a second, single elementary layer.

1. An antenna module comprising at least a first series of unitary radiating elements (ER₁ᵢ), a second series of unitary radiating elements (ER₂ᵢ) facing the unitary radiating elements of the first series, so as to broaden the frequency band of said antenna module, characterized in that it further includes:
a monolithic part (R) made of dielectric material having a face supporting the first series of radiating elements and legs (pₚ₁ᵢ), the surfaces (pₚ₁ᵢ) of which are conducting;
a microwave dielectric circuit (Cₕ) supporting the second series of radiating elements; and
means for fastening the legs of the monolithic part to said microwave dielectric circuit, the monolithic part providing a radome function for the radiating elements.

2. The antenna module as claimed in claim 1, characterized in that the surfaces of the legs are metalized.

3. The antenna module as claimed in claim 2, characterized in that the elements of the first series of radiating elements and the surfaces of the legs are made of the same metal.

4. The antenna module as claimed in either of claims 2 and 3 characterized in that the metal is nickel.

5. The antenna module as claimed in one of claims 1 to 4, characterized in that the constituent material of the monolithic part has a thermal expansion coefficient similar to that of the microwave dielectric circuit.

6. The antenna module as claimed in one of claims 1 to 5, characterized in that the dielectric constant of the monolithic part is around 3.

7. The antenna module as claimed in one of claims 1 to 6, characterized in that the constituent material of the monolithic part is a polycarbonate.

8. The antenna module as claimed in claim 7, characterized in that the polycarbonate includes glass fibers.

9. The antenna module as claimed in one of claims 1 to 8, characterized in that the fastening means comprise snap-fastening means.

10. The antenna module as claimed in one of claims 1 to 8, characterized in that the fastening means comprise screws.

11. The antenna module as claimed in one of claims 1 to 8, characterized in that the fastening means comprise spots of adhesive.

12. The antenna module as claimed in one of claims 1 to 11, characterized in that the microwave dielectric circuit is a multilayer circuit having various electrical functions.

13. The antenna module as claimed in one of claims 1 to 12, characterized in that the microwave dielectric circuit comprises an array of connections for addressing the various radiating elements.

14. The antenna module as claimed in one of claims 1 to 13, characterized in that it includes an array of connections for connecting said first radiating elements.

15. The antenna module as claimed in claim 14, characterized in that the array of connections is positioned in a stripline via a metalized through-hole or by electromagnetic contact.

16. A process for manufacturing an antenna module as claimed in one of claims 1 to 15, characterized in that it further comprises the following steps:
production of a conducting layer on the surface of the monolithic part having the legs;
discontinuous local removal of zones on the conducting layer produced so as to define the first series of radiating elements; and
fastening of said monolithic part to the microwave dielectric circuit comprising the second series of radiating elements.

17. The antenna module manufacturing process as claimed in claim 16, characterized in that the conducting layer is produced by catalytic deposition of a metal.

18. The antenna module manufacturing process as claimed in claim 16, characterized in that the conducting layer is produced by vapor deposition.

19. The antenna module manufacturing process as claimed in one of claims 16 to 18, characterized in that the local removal is carried out by etching.
